(19) United States
(12) Patent Application Publication
(10) Pub. No.: US 2021/0191397 A1
(43) Pub. Date: Jun. 24, 2021

(54) AUTONOMOUS VEHICLE SEMANTIC MAP ESTABLISHMENT SYSTEM AND ESTABLISHMENT METHOD

(71) Applicant: Industrial Technology Research Institute, Hsinchu (TW)

(72) Inventors: Li-Zen Lin, Taipei City (TW); Zong-Xian Guo, Taipei City (TW)

(73) Assignee: Industrial Technology Research Institute, Hsinchu (TW)

(21) Appl. No.: 16/726,249

(22) Filed: Dec. 24, 2019

(51) Int. Cl. G05D 1/00; G06K 9/00; G01C 21/30; G05D 1/02; B60W 60/00

(52) U.S. Cl. CPC G05D 1/0088; G06K 9/00805; G06K 9/00825; G06K 9/00818; G06K 9/00798; G01C 21/30; B60W 2556/45; G05D 1/0276; B60W 60/001; G05D 2201/0213; B60W 2420/42; B60W 2552/53; G05D 1/0212

(57) ABSTRACT

The disclosure provides an autonomous vehicle semantic map establishment system and an autonomous vehicle semantic map establishment method. The autonomous vehicle semantic map establishment system includes an image capturing module, a positioning module, a memory, and a processor. The image capturing module acquires a current road image. The positioning module acquires positioning data corresponding to the current road image. The memory stores three-dimensional (3D) map data. The 3D map data includes multiple point cloud data. The processor accesses the memory. The processor analyzes the current road image, to identify object information of a specific traffic object in the current road image. The processor marks, according to the positioning data, the object information of the specific object onto a plurality of corresponding points in the multiple point cloud data corresponding to the specific object in the 3D map data.

### BACKGROUND

### Technical Field

The technical field relates to a map establishment technology, and in particular, to an autonomous vehicle semantic map establishment system and an autonomous vehicle semantic map establishment method.

### Background

Currently when an autonomous vehicle is moving, the autonomous vehicle needs to analyze a large amount of map information in real time and perform real-time road detection and recognition to achieve effective automatic driving. That is, if the automatic control of an autonomous vehicle depends merely on real-time road detection and recognition, large amounts of computing time and computing resources are needed. Therefore, an autonomous vehicle control with an autonomous vehicle semantic map is a significant research direction in the known art currently. However, currently the autonomous vehicle semantic map is established by a user through drawing by means of manual setting according to a three-dimensional (3D) map model, and therefore large amounts of time and human resources are required. The establishment cost of an autonomous vehicle semantic map is thus excessively high, and human error may also exist. Several exemplary embodiments accompanied with figures are described in detail below to further describe the disclosure in details.

### SUMMARY

The disclosure provides an autonomous vehicle semantic map establishment system and an establishment method thereof which may provide an automatic and efficient map marking function.

The autonomous vehicle semantic map establishment system of the disclosure includes an image capturing module, a positioning module, a memory, and a processor. The image capturing module is configured to acquire a current road image. The positioning module is configured to acquire positioning data corresponding to the current road image. The memory is configured to store three-dimensional (3D) map data. The 3D map data includes multiple point cloud data. The processor is coupled to the image capturing module, the positioning module, and the memory. The processor is configured to access the memory. The processor analyzes the current road image, to identify object information of a specific object in the current road image. The processor marks, according to the positioning data, the object information of the specific object onto a plurality of corresponding points in the multiple point cloud data corresponding to the specific object in the 3D map data.

The autonomous vehicle semantic map establishment method of the disclosure includes the following steps: acquiring a current road image; acquiring positioning data corresponding to the current road image; analyzing the current road image, to identify object information of a specific object in the current road image; and marking, according to the positioning data, the object information of the specific object onto a plurality of corresponding points in the multiple point cloud data corresponding to the specific object in the 3D map data.

Based on the foregoing statement, in the autonomous vehicle semantic map establishment system and the establishment method disclosed, first the object information of the specific object in current road image is identified, and then the object information of the specific object is marked onto the 3D map data, to effectively establish an autonomous vehicle semantic map usable for an autonomous vehicle when performing automatic driving.

In order to make the aforementioned and other objectives and advantages of the disclosure comprehensible, embodiments accompanied with figures are described in detail below.

### BRIEF DESCRIPTION OF THE DRAWINGS

FIG. 1 is a schematic view of an autonomous vehicle semantic map establishment system according to an embodiment of the disclosure.

FIG. 2 is a flowchart of an autonomous vehicle semantic map establishment method according to an embodiment of the disclosure.

FIG. 3 is a schematic view of a current road image according to an embodiment of the disclosure.

FIG. 4 is a flowchart of a map marking method according to an embodiment of the disclosure.

FIG. 5 is a schematic marking view of a current road image and three-dimensional (3D) map data according to an embodiment of the disclosure.

FIG. 6 is a flowchart of planning a movement route according to an embodiment of the disclosure.

FIG. 7 is a schematic planning diagram of a movement route according to an embodiment of the disclosure.

### DETAILED DESCRIPTION OF DISCLOSED EMBODIMENTS

In order to make the aforementioned and other contents of the disclosure comprehensible, embodiments are described in detail below to illustrate the disclosure may be applied. In addition, whenever possible, same units/components/steps used in the figures and the embodiments represent same or similar parts.

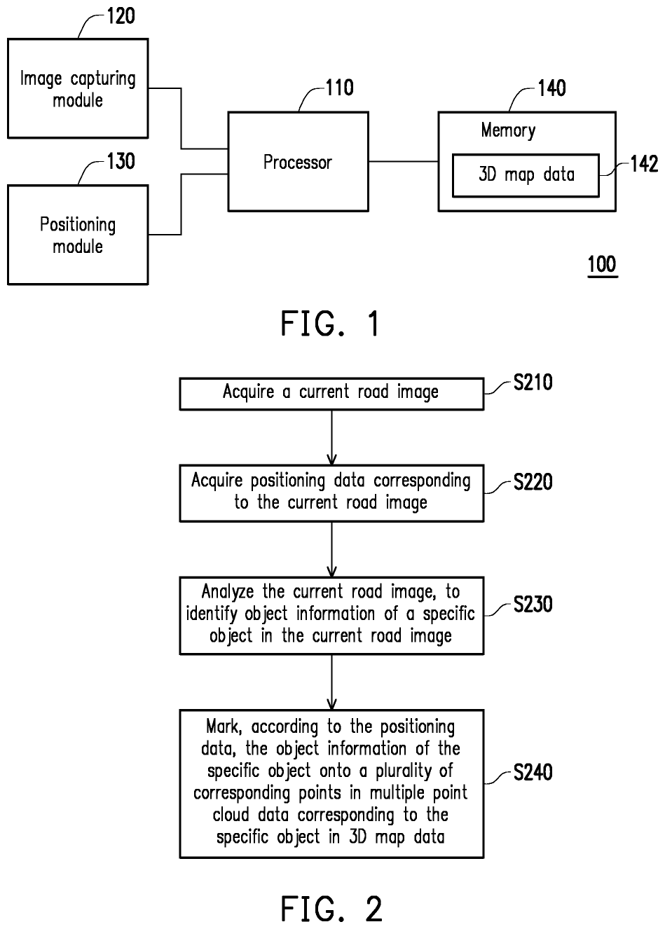

FIG. 1 is a schematic view of an autonomous vehicle semantic map establishment system according to an embodiment of the disclosure. Referring to FIG. 1, the autonomous vehicle semantic map establishment system 100 includes a processor 110, an image capturing module 120, a positioning module 130, and a memory 140. The memory is configured to store three-dimensional (3D) map data 142. The processor 110 is coupled to the image capturing module 120, the positioning module 130, and the memory 140. In this embodiment, the autonomous vehicle semantic map establishment system 100 may be configured in an autonomous vehicle. The autonomous vehicle may be, for example, a self-driving car, an autonomous ship, or an unmanned aerial vehicle (UAV), and other devices that may implement automatic driving. When an autonomous vehicle is moving on a route, the image capturing module 120 may continuously capture road images immediately, and provide the road images to the processor 110 for analyzing. At the same time, the positioning module 130 may continuously provide positioning data to the processor 110 immediately. Therefore, the processor 110 may mark specific object information in the 3D map data 142 according to the corresponding positioning data in the analysis result of the road image, to implement efficient map marking. In addition, the 3D map data 142 marked with the specific object information may be provided to an autonomous vehicle for reading and using when performing automatic driving.

In this embodiment, the processor 110 may be, for example, a central processing unit (CPU), or other programmable microprocessor for general purpose or special purpose, digital signal processor (DSP), programmable controller, application specific integrated circuits (ASIC), programmable logic device (PLD), other similar processing devices, or any combination of the foregoing devices.

In this embodiment, the image capturing module 120 may be, for example, a camera, and may be, for example, configured at a peripheral position on the autonomous vehicle, to provide a real-time road image (two-dimensional image) of a peripheral area of the vehicle to the processor 110. The processor 110 may, for example, identify the shape and analyze the image of the real-time road image, to identify an object classification of the specific object in the real-time road image.

In this embodiment, the positioning module 130 may, for example, acquire regional coordinates (a relative location) of the autonomous vehicle on a light detection and ranging (Lidar) map from the Lidar map, or for example, acquire longitude and latitude coordinates (an absolute location) by using the Global Positioning System (GPS). In addition, the positioning module 130 may be configured on the autonomous vehicle, to immediately provide the positioning data of the autonomous vehicle to the processor 110. The processor 110 may, for example, access a 3D route model corresponding to the real-time road image in the 3D map data 142 correspondingly according to the positioning data, for the convenience of the projection of point cloud data and the utilization of map marking described in the following embodiments.

In this embodiment, the memory 140 may be, for example, a Dynamic Random Access Memory (DRAM), a Flash memory, or a Non-Volatile Random Access Memory (NVRAM) and the like. In this embodiment, the memory 140 may be configured to store the 3D map data 142, relevant image processing program, and image data, for being read and executed by the processor 110.

It should be noted that, in this embodiment, the 3D map data 142 may be a 3D point cloud model, and the 3D point cloud model may be established after being sensed by a Lidar device on the route in advance. The disclosure does not limit a form in which the 3D map data 142 is acquired. Original point cloud data of each point of the 3D point cloud model may include, for example, 3D coordinate data, strength data, or color data, and the like. In addition, the autonomous vehicle semantic map establishment system 100 in this embodiment further marks the object information of the specific object in the corresponding specific point cloud of the 3D point cloud model.

In addition, in this embodiment, the processor 110, the image capturing module 120, the positioning module 130, and the memory 140 of the autonomous vehicle semantic map establishment system 100 may all be configured in the autonomous vehicle, but it is not limited hereto in the disclosure. In an embodiment, the image capturing module 120 and the positioning module 130 may be configured in an autonomous vehicle, and the processor 110 and the memory 140 may be configured in a cloud server. Therefore, the autonomous vehicle may be in wireless communication with the cloud server, to transmit a current road image and positioning information to the cloud server for calculating, and to perform map marking. In another embodiment, the map marking may also be executed by other computer devices in an offline state according to an image recorded in advance, and load the relevant marked map information to the autonomous vehicle.

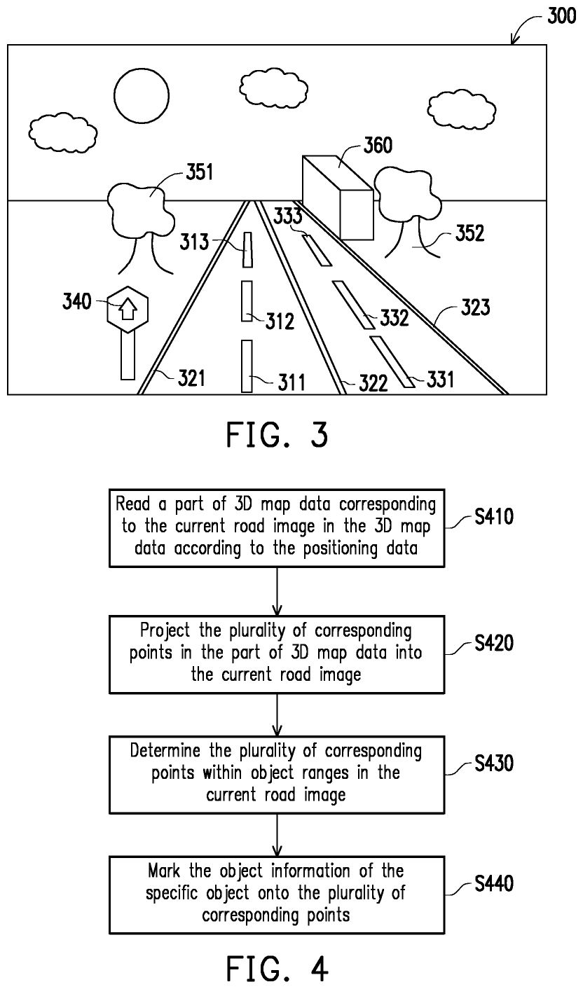

FIG. 2 is a flowchart of an autonomous vehicle semantic map establishment method according to an embodiment of the disclosure. FIG. 3 is a schematic view of a current road image according to an embodiment of the disclosure. Referring to FIG. 1 to FIG. 3, the autonomous vehicle semantic map establishment system 100 may execute steps S210-S240 to implement establishment of the autonomous vehicle semantic map, and it is illustrated below with reference to an image of the road in front of a self-driving car in FIG. 3. In step S210, the autonomous vehicle semantic map establishment system 100 may acquire a current road image 300 by using the image capturing module 120. The current road image 300 is an image of the current road in front of the self-driving car. In step S220, the autonomous vehicle semantic map establishment system 100 may acquire positioning data corresponding to the current road image 300 by using the positioning module 130. That is, the positioning module 130 may provide the positioning data of a current location of the autonomous vehicle. In step S230, the processor 110 may analyze the current road image, to identify object information of a specific object in the current road image 300. In this case, in FIG. 3, the specific object may refer to a specific traffic object in the road image, and the object information may refer to traffic object information of the traffic object.

It should be noted that, as shown in FIG. 3, the current road image 300 may include road markings 311-313, 322 and 331-333, road boundaries 321 and 323, a traffic sign 340, road trees 351 and 352, a building 360 and the like which are on the ground. In this embodiment, the processor 110 may identify, by using a machine learning module trained in advance such as a deep learning module, the specific object in the current road image 300, such as the road markings 311-313, 322 and 331-333, the road boundaries 321 and 323, and the traffic sign 340, to acquire the object information of the road markings 311-313, 322 and 331-333, the road boundaries 321 and 323, and the traffic sign 340. In this embodiment, the traffic object information may include information such as marking directions of the road markings 311-313, 322 and 331-333, the road boundaries 321 and 323, and respective location, classification, and shape of the traffic sign 340, and other information, and it is not limited hereto in the disclosure.

It should be noted that, the specific object of the disclosure is not limited hereto. By an example of a scenario in which a self-driving car is driving on a road, the specific object of the disclosure may be a road lamp, a traffic sign, a traffic light, a road sign, a parking sign, a road boundary, a road marking, or other objects of the kind. In addition, because the road trees 351 and 352, and the building 360 are not map information which the self-driving car is interested in, the processor 110 may not identify the road trees 351 and 352, and the building 360, to effectively reduce unnecessary processor operation. In addition, in another embodiment, the object information of the road markings 311-313, 322 and 331-333, the road boundaries 321 and 323, and the traffic sign 340 may also be input by the user by means of manual editing.

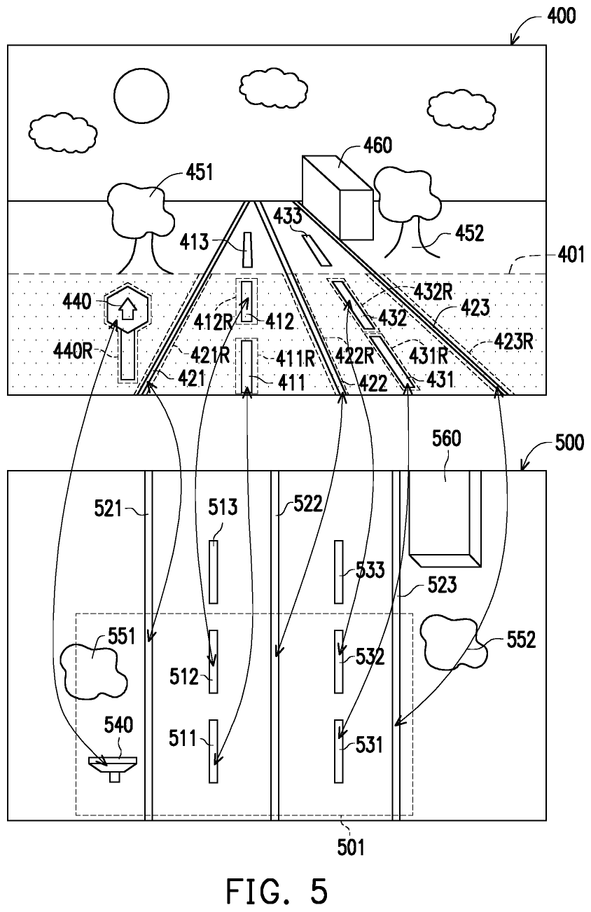

In step S240, the processor 110 may mark, according to the positioning data, the object information of the specific object onto a plurality of corresponding points in the multiple point cloud data corresponding to the specific object in the 3D map data 142. That is, the autonomous vehicle semantic map establishment system 100 may write multiple traffic object information of the road markings 311-313, 322 and 331-333, and the road boundaries 321 and 323 into the multiple point cloud data of 3D models corresponding to the road markings 311-313, 322 and 331-333, the road boundaries 321 and 323, and the traffic sign 340 in the 3D map data 142. In this case, when the autonomous vehicle is performing automatic driving, the autonomous vehicle may implement a function of automatic driving according to the 3D map data 142 marked with the object information of the specific object. However, a specific marking method of the traffic object information in this embodiment is illustrated in detail by using the embodiments of FIG. 4 and FIG. 5.

FIG. 4 is a flowchart of a map marking method according to an embodiment of the disclosure. FIG. 5 is a schematic marking view of a current road image and 3D map data according to an embodiment of the disclosure. Referring to FIG. 1, FIG. 4, and FIG. 5, in this embodiment, the autonomous vehicle semantic map establishment system 100 may execute steps S410-S440 to implement map marking, and it is illustrated below with reference to an image of the road in front of a self-driving car in FIG. 5. Steps S410-S440 may also be extended implementation examples of step S240 in the embodiment of FIG. 2. It should be clarified that in this embodiment, the processor 110 may analyze a specific object in a part of the current road image 400 according to a preset identification threshold. The preset identification threshold may be, for example, determined by a fixed distance of a peripheral area of the autonomous vehicle or a fixed height of the autonomous vehicle from the ground. That is, in this embodiment, because the autonomous vehicle is continuously advancing, the processor 110 may first analyze the road image within a fixed range in front of the autonomous vehicle. Because the specific objects which the autonomous vehicle are interested in are mostly within a fixed range around the autonomous vehicle or lower than a fixed height from a specific surface (for example, the ground), the processor 110 does not need to analyze unimportant areas in the road image, to effectively reduce the operation recourses of the autonomous vehicle semantic map establishment system 100.

As shown in the current road image 400 in FIG. 5, the processor 110 of this embodiment may merely analyze and identify the road image below a reference line 401. In addition, in step S230, the processor 110 may further determine an object range for a specific object in the current road image 400. That is, in the road image below the reference line 401, the processor 110 may define the object ranges 411R, 412R, 421R, 422R, 423R, 431R, 432R, and 440R of the road markings 411-413, 422 and 431-433, the road boundaries 421 and 423, and the traffic sign 440. In addition, as shown in the 3D map data 500 in FIG. 5, the 3D map data 500 includes road marking models 511-513, 522 and 531-533, road boundary models 521 and 523, a traffic sign model 540, road tree models 551 and 552, and a building model 560 which are formed by multiple point clouds.

Based on the foregoing multiple prerequisites, the autonomous vehicle semantic map establishment system 100 performs following steps S410-S440. In step S410, the processor 110 reads a part of 3D map data 501 corresponding to the current road image 400 in the 3D map data 500 according to the positioning data. In this embodiment, the part of 3D map data 501 is a part that is the region of interest (ROI) corresponding to the current road image 400 in the 3D map data 500, and a range of the ROI may be determined according to a visible range and/or a configuration angle of the image capturing module 120. In step S420, the processor 110 projects the plurality of corresponding points in the part of 3D map data 501 into the current road image 400. As shown in FIG. 5, the processor 110 projects the location of each data point of the multiple point clouds in the part of 3D map data 501 into the current road image 400 (for example, the road image below the reference line 401) via coordinate transformation.

Subsequently, in step S430, the processor 110 determines the plurality of corresponding points within the object ranges 411R, 412R, 421R, 422R, 423R, 431R, 432R, and 440R in the current road image 400. That is, the processor 110 leaves multiple point clouds corresponding to the road marking models 511, 512, 522, 531 and 532, the road boundary models 521 and 523, and the traffic sign model 540 within the object ranges 411R, 412R, 421R, 422R, 423R, 431R, 432R, and 440R. In step S440, the processor 110 marks the object information of the specific object onto the plurality of corresponding points. That is, the processor 110 marks the respective pieces of object information of the road markings 411-413, 422 and 431-433, the road boundaries 421 and 423, and the traffic sign 440 to the plurality of corresponding points in the multiple point cloud data within the object ranges 411R, 412R, 421R, 422R, 423R, 431R, 432R, and 440R. In addition, in this embodiment, the processor 110 updates the marked multiple point cloud data to the plurality of corresponding points in the multiple point clouds of the road marking models 511, 512, 522, 531 and 532, the road boundary models 521 and 523, and the traffic sign model 540 in the 3D map data 142 in the memory 140. Accordingly, by the map marking method in this embodiment, the autonomous vehicle semantic map establishment system 100 may perform the map marking automatically, efficiently and reliably.

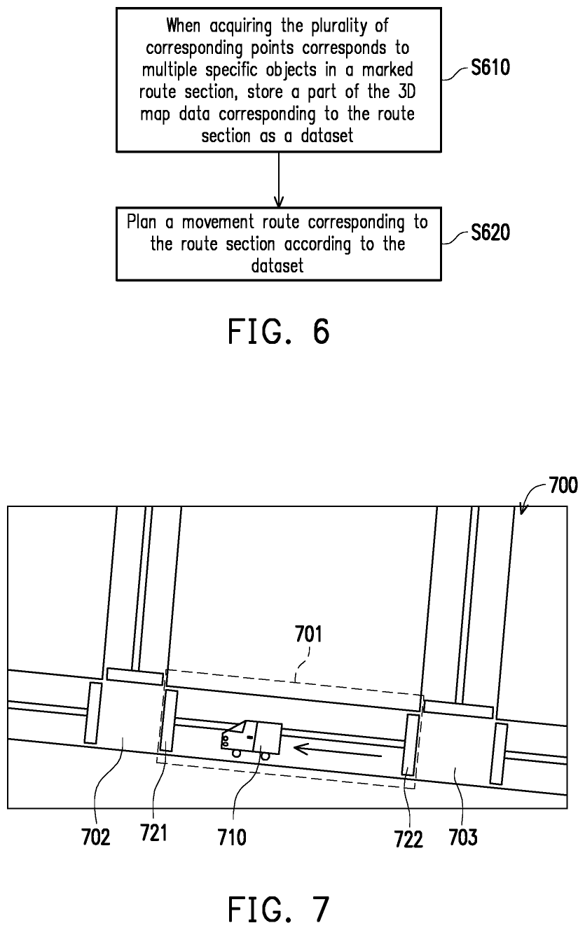

FIG. 6 is a flowchart of planning a movement route according to an embodiment of the disclosure. FIG. 7 is a schematic planning diagram of a movement route according to an embodiment of the disclosure. Referring to FIG. 1, FIG. 6, and FIG. 7, the autonomous vehicle semantic map establishment system 100 may execute steps S610-S640 to implement planning of the movement route, and it is illustrated below with reference to a driving environment 700 of the self-driving car in FIG. 7. In step S610, when an autonomous vehicle 710 acquires the plurality of corresponding points in the multiple point cloud data of multiple specific objects in a marked route section 701 by the autonomous vehicle semantic map establishment system 100, the processor 110 stores a part of 3D map data corresponding to the route section 701 as a dataset.

It should be noted that, the route section 701 refers to the route between two intersections 702 and 703, and includes the two intersections 702 and 703. The autonomous vehicle semantic map establishment system 100 may define a start location and a finish location of the route section 701 according to the intersections 702 and 703 corresponding to the identified driveway stop lines 721 and 722. In step S620, the processor 110 may plan a movement route corresponding to the route section 701 according to the dataset. In this case, the movement route refers to a driving route (for example, a linear driving route or a nonlinear driving route) of the autonomous vehicle 710 in the road boundary between the intersections 702 and 703. That is, the method for storing the semantic map of the autonomous vehicle semantic map establishment system 100 in this embodiment is storing the 3D map data of each road section as a dataset, so that the autonomous vehicle can read corresponding dataset when passing a route section, and may determine a driving route quickly. However, the driving routes of the intersections 702 and 703 are determined based on whether the autonomous vehicle 710 turns, and the disclosure does not limit the route planning method of intersections.

Based on the above, by the autonomous vehicle semantic map establishment system and the autonomous vehicle semantic map establishment method of the disclosure, object information of specific objects is quickly marked onto the plurality of corresponding points in the multiple point cloud data of 3D map data by projecting the plurality of corresponding points in the part of the 3D map data into object ranges for specific objects in a current road image, and therefore an efficient autonomous vehicle semantic map establishment function is provided. In addition, by the autonomous vehicle semantic map establishment system and the autonomous vehicle semantic map establishment method of the disclosure, a marking result of a route section may further be stored as a dataset, so that the autonomous vehicle can implement planning of a movement route quickly when performing automatic driving.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An autonomous vehicle semantic map establishment system, comprising:
an image capturing module, configured to acquire a current road image;
a positioning module, configured to acquire positioning data corresponding to the current road image;
a memory, configured to store three-dimensional (3D) map data, wherein the 3D map data comprises multiple point cloud data; and
a processor, coupled to the image capturing module, the positioning module, and the memory, and configured to access the memory, wherein
the processor analyzes the current road image, to identify object information of a specific object in the current road image, and the processor marks, according to the positioning data, the object information of the specific object onto a plurality of corresponding points in the multiple point cloud data corresponding to the specific object in the 3D map data.

2. The autonomous vehicle semantic map establishment system according to claim 1, wherein the processor further determines an object range for the specific object in the current road image, and the processor reads, according to the positioning data, a part of 3D map data that is in the 3D map data and corresponds to the current road image; and
the processor projects the plurality of corresponding points in the part of 3D map data into the current road image, and the processor determines the plurality of corresponding points within the object range in the current road image, so as to mark the object information of the specific object onto the plurality of corresponding points.

3. The autonomous vehicle semantic map establishment system according to claim 2, wherein the part of 3D map data is a part that is a region of interest (ROI) in the 3D map data which corresponds to the current road image, and a range of the ROI is determined according to a visible range and/or a configuration angle of the image capturing module.

4. The autonomous vehicle semantic map establishment system according to claim 1, wherein the processor updates the marked plurality of corresponding points to the 3D map data in the memory.

5. The autonomous vehicle semantic map establishment system according to claim 1, wherein the processor analyzes a part of the current road image according to a preset identification threshold, to identify the specific object in the current road image.

6. The autonomous vehicle semantic map establishment system according to claim 1, wherein the processor identifies the object information of the specific object in the current road image by using a machine learning module trained in advance.

7. The autonomous vehicle semantic map establishment system according to claim 1, wherein the autonomous vehicle semantic map establishment system is adapted to a self-driving car, and the specific object is a road lamp, a traffic sign, a traffic light, a road sign, a parking sign, a road boundary, or a road marking.

8. The autonomous vehicle semantic map establishment system according to claim 1, wherein when the processor finishes marking the plurality of corresponding points corresponds to multiple specific objects in a route section, the processor stores the part of the 3D map data corresponding to the route section as a dataset.

9. The autonomous vehicle semantic map establishment system according to claim 8, wherein the processor plans a movement route corresponding to the route section according to the dataset.

10. The autonomous vehicle semantic map establishment system according to claim 1, wherein the autonomous vehicle semantic map establishment system is configured in an autonomous vehicle.

11. The autonomous vehicle semantic map establishment system according to claim 1, wherein the image capturing module and the positioning module are configured in an autonomous vehicle, and the memory and the processor are configured in a cloud server, wherein the autonomous vehicle is in wireless communication with the cloud server, to transmit the current road image and the positioning information to the cloud server for calculating.

12. An autonomous vehicle semantic map establishment method, comprising:
acquiring a current road image;
acquiring positioning data corresponding to the current road image;
analyzing the current road image, to identify object information of a specific object in the current road image; and
marking, according to the positioning data, the object information of the specific object onto a plurality of corresponding points in multiple point cloud data corresponding to the specific object in three-dimensional (3D) map data.

13. The autonomous vehicle semantic map establishment method according to claim 12, wherein the step of analyzing the current road image further comprises determining an object range for the specific object in the current road image, and the step of marking, according to the positioning data, the object information of the specific object onto the plurality of corresponding points in the multiple point cloud data corresponding to the specific object in the 3D map data comprises:
reading, according to the positioning data, a part of 3D map data that is in the 3D map data and corresponds to the current road image;
projecting the plurality of corresponding points in the part of 3D map data into the current road image;
determining the plurality of corresponding points within the object range in the current road image; and
marking the object information of the specific object onto the plurality of corresponding points.

14. The autonomous vehicle semantic map establishment method according to claim 13, wherein the part of 3D map data is a part that is a region of interest (ROI) in the 3D map data which corresponds to the current road image, and a range of the ROI is determined according to a visible range and/or a configuration angle of an image capturing module.

15. The autonomous vehicle semantic map establishment method according to claim 12, wherein the step of marking, according to the positioning data, the object information of the specific object onto the plurality of corresponding points in the multiple point cloud data corresponding to the specific object in the 3D map data further comprises:
updating the marked plurality of corresponding points to the 3D map data.

16. The autonomous vehicle semantic map establishment method according to claim 12, wherein the step of analyzing the current road image, to identify the object information of the specific object in the current road image comprises:
analyzing a part of the current road image according to a preset identification threshold, to identify the specific object in the current road image.

17. The autonomous vehicle semantic map establishment method according to claim 12, wherein the step of analyzing the current road image, to identify the object information of the specific object in the current road image comprises:
identifying the object information of the specific object in the current road image by using a machine learning module trained in advance.

18. The autonomous vehicle semantic map establishment method according to claim 12, wherein the autonomous vehicle semantic map establishment method is adapted to a self-driving car, and the specific object is a road lamp, a traffic sign, a traffic light, a road sign, a parking sign, a road boundary, or a road marking.

19. The autonomous vehicle semantic map establishment method according to claim 12, further comprising:
when acquiring the plurality of corresponding points corresponds to multiple specific objects in a marked route section, storing the part of the 3D map data corresponding to the route section as a dataset.

20. The autonomous vehicle semantic map establishment method according to claim 19, further comprising:
planning a movement route corresponding to the route section according to the dataset.
